(19) United States
(12) Patent Application Publication
(10) Pub. No.: US 2011/0203434 A1
(43) Pub. Date: Aug. 25, 2011

(54) Restiform food slicer

(76) Inventor: Uwe Reifenhaeuser, Flammersfeld (DE)

(21) Appl. No.: 12/932,333

(22) Filed: Feb. 23, 2011

(30) Foreign Application Priority Data
Feb. 24, 2010 (DE) DE 102010002279.9

(51) Int. Cl. B26D 7/06

(52) U.S. Cl. 83/111

(57) ABSTRACT

A machine (1) for cutting a strand shaped food material, in particular meat or cheese into slices, comprising: a feed portion (2); a cutting device (3); and a conveying portion (4), wherein a food material strand (63) is moveable in feed direction (38) from the feed portion (2) through a feed device (37) towards the cutting device (3) including a rocker (6) pivoting about a first rotation axis (7) fixated at a housing, wherein a circular blade (10) is supported at the rocker and configured to be driven in rotation about a second rotation axis (9) and configured to cut successive slices from a front face of the food material strand (63), wherein the slices are transferable into the conveying portion (4) after being cut off from the food material strand (63), wherein the feed device (38) is substantially horizontal, and wherein a circular path (K) on which the second rotation axis (9) orbits is arranged completely outside of a maximum cross section.

### RELATED APPLICATIONS

This patent application claims priority from and incorporates by reference German patent application DE 10 2010 002 279.9, filed on Feb. 24, 2010.

### FIELD OF THE INVENTION

The invention relates to a machine for cutting strand-shaped foods, in particular meat or cheese, into slices, the machine including a feed portion, a cutting device and a conveying, portion wherein a food strand is feedable in feed direction from the feed portion through a feed device towards the cutting device, wherein the cutting device includes a rocker that rotates about a first rotation axis that is fixated relative to the housing, wherein the cutting device also includes a circular blade that is supported rotatable about a second rotation axis arranged at the rocker, wherein the circular blade is configured to cut off successive slices from a front side of the food strand, wherein the slices are transferable into the conveying portion after being cut off from the food strand, wherein the feed device is substantially horizontal.

A substantially horizontal feed direction shall designate deviations from a horizontal of 10° at the most according to the present application.

### BACKGROUND OF THE INVENTION

A machine of the type recited supra was already produced and sold as pork chop slicer type ROK by Berkel Deutschland GmbH in the 1980's. In order to keep the space requirements for the machine as small as possible and in particular in order to also be able to operate with a small diameter of the circular blade, the drive within the rocker is covered with a wedge shaped cover. This facilitates that the circular blade can pass with its rotation axis and a portion of the cover through the cross-section of the food strand since the slices that are being produced are deflected forward, this means in feed direction, through the beveled wedge shape of the rocker housing.

In particular when cutting foods including bones, e.g. pork chops, prior art machines have their problems. Namely when cutting off slices bone splinters are typically being formed, wherein the bone splinters adhere to the cut off slices and cause a cutting quality that is perceived inadequate. In particular when the cut foods are immediately packaged into self-service trays after producing the slices, a potential splinter formation can neither be controlled nor can potential splinters eventually be removed.

A machine with a similar basic principle is disclosed as a bread slicing machine according to DE A 103 12 301 and EP-A 1 520 666. Also here the rocker of the orbital disc blade is covered with a flat wedge shaped cover. The wedge affect of the rocker when passing through the bread cross-section, however, only leads to an elastic deflection of the slice being made and is not detrimental for the cutting result. Namely in bread slicing machines it is often important to keep the dimensions small since machines of this type are typically set up in bakery stores where there is only limited space available.

Circular blades with an orbital drive are furthermore also used in the genus of so-called slicers which are used to cut boneless cold cuts like sausage, ham, cheese or similar into thin slices of 0.5 mm to 2 mm thickness. Thus, the food strand is fed to the cutting device either hanging in a vertical direction or at a slant angle with 30° to 60° relative to horizontal.

### BRIEF SUMMARY OF THE INVENTION

Thus, it is an object of the invention to improve a machine for cutting strand shaped foods, in particular meat or cheese into slices so that very high cutting quality and high cutting performance can be obtained.

Starting with a cutting machine as recited supra the object is achieved in that the circular path on which the second rotation axis moves is arranged completely outside of the maximum cutting cross-section.

In the machine according to the invention it is thus omitted when cutting portions to run the rotation axis of the circular blade and thus also a portion of the rocker through the cross-section of the food strand. This makes it necessary to select circular blades with a large diameter, since as a matter of principle less than half the diameter is available in order to cover the maximum cutting cross-section for an orbit of the rocker, this means to cover the feed cross-section that is geometrically available in the feed portion. Thus, in the machine according to the invention the rocker moves outside of the cutting cross-section and can therefore not have any negative affect on the cutting process, this means in particular no “dull pressure loading” can occur in the slot portion between the portion of the slice that has already been cut off and the remaining rest of the food strand.

The inventors have found that the cutting machine according to the invention facilitates cutting in particular bone including foods and partially frozen or completely frozen food strands in an excellent cutting quality into portions. In particular the splintering of bones as it was unavoidable in the pork chop cutting machine recited supra was prevented with a high degree of reliability. The slice thickness for the machine according to the invention is typically between 5 and 30 mm.

In order to obtain particularly good cutting quality the first rotation axis about which the rocker rotates can be arranged above a straight line defining an opposite blade of the feed portion, preferably above a horizontal center plane of the maximum cutting cross-section and/or at a distance laterally adjacent to a straight line which laterally defines the maximum cutting cross-section. The rotation direction of the rocker rotation thus has to be selected so that the circular blade enters the cutting cross-section at a slant angle from above which always creates a large contact pressure of the food strand onto the opposite cutting edge of the feed portion or on a diagonally opposed lower corner portion of the cutting cross-section and a lift-off of the food strand from a contact surface of the feed portion is safely prevented.

The cutting result is furthermore influenced in a particularly positive manner when a horizontally extending opposite cutting edge of the feed portion and an opposite horizontally extending opposite cutting edge of the conveying portion extend approximately at the same level. Supporting the forces created when cutting in particular bone including foods is particularly advantageous for an arrangement of this type of the two opposite cutting edges. The gap portion between the opposite cutting edges thus exceeds the thickness of the circular blade only far enough (typically in a range of tenths of millimeters) as this is required for a contact-free passage of the circular blade.

According to an embodiment of the invention it is provided that the rocker on the one hand side and the circular blade on the other hand side are respectively drivable with a proper drive motor. This has the advantage that in particular the ratio of the speed of the circular blade to the speed of the rocker is easily variable. At least one of the two drives shall be provided with a frequency inverter for speed control. As a matter of principle it is also within the scope of the invention that the rocker and also the circular blade are driven through the same drive which yields a fixed speed ratio of rocker and circular blade.

In order to obtain a particularly good cutting result, in particular a saw affect through the circular blade, the ratio of the speed of the circular blade to the speed of the rocker for a non-frozen food shall be at least 3:1 and/or for a partially frozen or completely frozen food at least 6:1, preferably at least 8:1. In order to prevent a smearing of the food a lower ratio has to be selected for a non-frozen food than for partially frozen or completely frozen foods, wherein a speed of the circular blade that is as high as possible should be implemented for a “circular saw.”

It is furthermore advantageous in particular when the circular blade has a thickness of less than 10 mm, preferably less than 8 mm, particularly preferably less than 6 mm. With a decreasing thickness of the blade the wedge affect upon the food and thus also the force required for the cutting process is reduced. This reduces in particular also the risk that splinters are generated when cutting through a bone. Furthermore the diameter of the circular blade should be at least 500 mm, preferably at least 600 mm, particularly preferably at least 700 mm.

In order to reduce the friction between the blade and the food during the cutting process a circular blade can be provided according to the invention which has an undercut on both sides subsequent to a wedge portion in the longitudinal sectional view. This helps to prevent that the circular blade in the undercut portion, this means thickness reduced portion comes in contact with the face of the remaining food strand and also with the lateral surface of the slice that is being produced. This also helps to reduce the lateral forces onto the slice that is being produced and improves the geometry of the produced portions which is important in particular in view of the object of producing precisely weighted portions.

A conveyor belt shall be preferably arranged in the conveying portion of the machine, wherein the conveyor belt should directly join a cutting frame arranged in the conveying portion and forming an opposite cutting edge. This way a controlled and efficient conveying of the cut slices is provided which helps the machine according to the invention achieve high cutting performance. An automated packaging device can be attached to the conveying band.

It is furthermore proposed according to the invention that a cutting frame of the feed portion and/or a cutting frame of the conveying portion is assembled from a main component that is integrally configured in one piece and a vertical connection arm which is oriented towards the first axis of rotation and which connects ends of two U-arms of the main component. In an embodiment of this type in particular the lower corner portion between the opposite cutting edge and the vertical connection arm of the U-shaped main component is integrally configured from one solid piece in order to support the large forces that occur in this portion during cutting operations safely and without deformation. On the other hand side the connection arm oriented towards the rocker, wherein the connection arm closes the U to form a rectangular frame, can be configured very thin so that the rocker can be moved as closely as possible to the cutting cross-section defined by the free space within the cutting frame. This in turn facilitates implementing the largest possible cutting cross-section for a diameter of the circular blade that is as small as possible.

Furthermore it is provided for the machine according to the invention that an opposite cutting edge of the conveying portion, preferably a cutting frame of the conveying portion at which the opposite cutting edge of the conveying portion is formed is permanently attached at an opposite cutting edge of the feed portion, preferably with a cutting frame of the feed portion at which the opposite cutting edge of the feed portion is configured. Preferably the opposite cutting edge of the conveying portion or the cutting frame including the conveying portion is permanently connected to a machine frame, wherein the conveying band in turn is attached to a door of the cutting box, wherein the door is attached so that it is pivotable about a vertical axis at the machine frame or the conveying portion. This helps to obtain an interconnection of the two opposite cutting edges or cutting frames which is important for a safe reaction of the opposing forces occurring during cutting operations in a vertical direction or in a downward slanted direction. In this case in particular there is no necessity to configure the linked suspension of a cutting box door solid enough so that it can support the opposing forces occurring on a side of the transport portion into the machine frame which would be necessary when the opposite cutting edge disposed on the side of the conveying portion, or the cutting frame disposed at this portion were attached at the door of the cutting box. Thus, according to the invention a very stable and simple configuration of the opposite cutting edges is provided that is combined with the advantage of good accessibility of the portion in which the cutting box door with the conveying band attached thereto is being opened.

Eventually the cutting frame of the conveying portion at its horizontal arm should be configured with a ramp in a cross-sectional view, wherein one surface of the arm that is oriented away from the cutting device slopes downward from the opposite cutting edge in conveying direction. The angle of the ramp should be approximately 30° to 60° relative to horizontal.

### BRIEF DESCRIPTION OF THE DRAWINGS

The invention is subsequently described with reference to a preferred embodiment of a cutting machine with reference to drawing figures wherein:

FIGS. 1-5 illustrate views of an opened cutting box of the machine in different rotation positions of the rocker without the circular blade and with the circular blade;

FIGS. 6 and 7 illustrate enlarged views of the cutting frames;

FIGS. 8-10 illustrate different perspective views of the feed portion of the machine;

FIG. 11 illustrates an enlarged view according to FIG. 10;

FIGS. 12 and 13 respectively illustrate perspective views of the feed element of the feed device;

FIG. 14 illustrates a longitudinal sectional view of the feed portion of the machine with an inserted food strand; and

FIG. 15 illustrates a view of the cutting frames and of the hold-down device with a food strand in the cutting cross-section.

### DETAILED DESCRIPTION

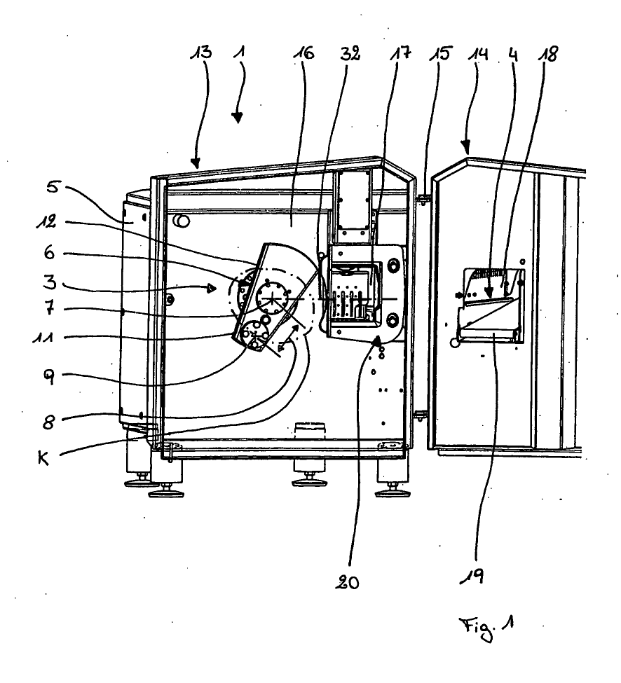

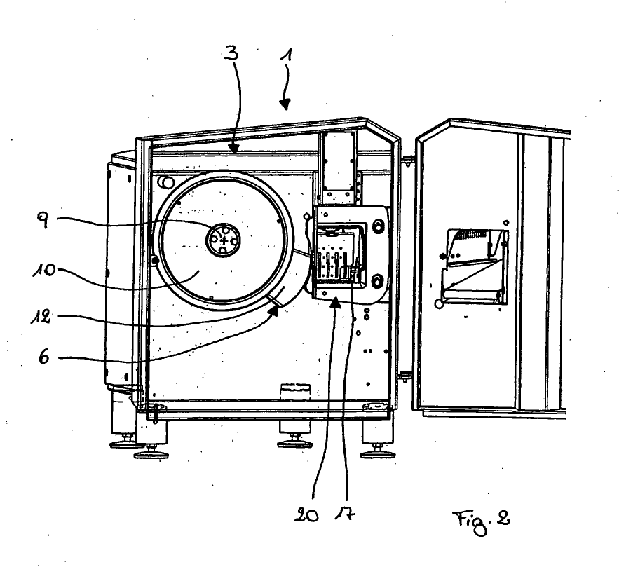

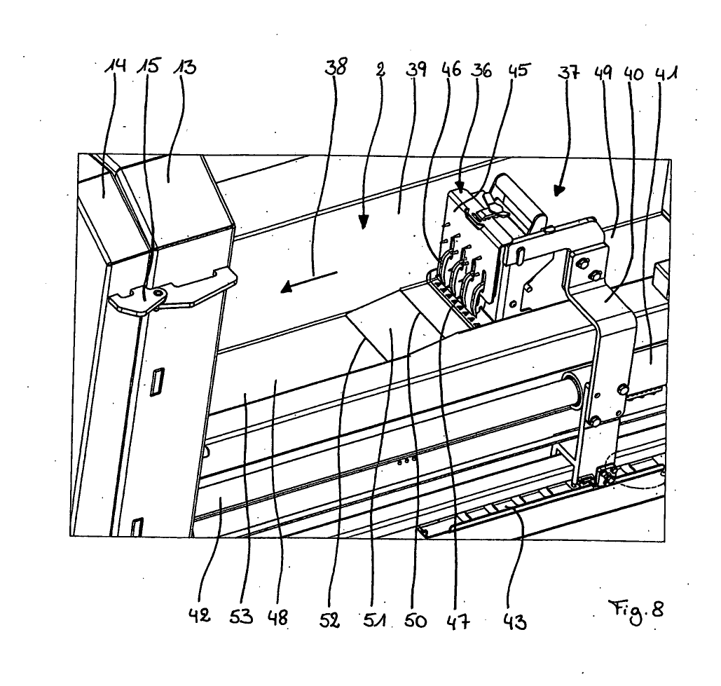

A machine 1 which is known in the art with respect to its basic principle includes a feed portion 2 which is visible in particular in FIGS. 8-10, a cutting device 3 depicted in FIGS. 1-7 and a conveying device 4 for cut-off slices portions that is visible in the best manner in FIGS. 1-6. The cutting device 3 includes a rocker 6 that is rotatably supported within a machine housing 5, wherein the rocker rotates during cutting operations about a rotation axis 7 that is horizontally aligned and extends parallel to a feed direction. A rotation axis 9 is disposed at the rocker 6 at a distance 8 from the rotation axis 7, wherein a circular blade 10 rotates about the rotation axis 9, wherein the circular blade is not illustrated in FIG. 1, but in FIGS. 2-7. The rocker 6 includes a first rocker arm 11 at which the rotation axis 9 of the circular blade 10 is arranged and an opposite rocker arm 12 whose width is increased relative to the rocker arm 11 and which is used as a counterweight to the circular blade 10. A drive motor that is not visible in the figures is disposed in the interior of the machine housing 5 and is used as a drive for the rocker 6 and also for the circular blade 10 rotating thereon about its proper rotation axis 9. The distance 8 corresponds to a radius of an orbit of the center of the circular blade 10.

A so-called cutting box 13 is arranged at a face of the machine housing 5 that is visible in FIGS. 1-5 wherein the rocker 6 and the circular blade 10 are protected against external access during cutting operations of the machine 1. The closing of the cutting box 13 is performed through a cutting box door 14 which is pivotably supported at two hinges 15 about a vertical axis at the machine housing 5 or at the side wall of the cutting box 13.

Within a face wall 16 of the machine housing 5, wherein the face wall is oriented towards the feed portion 2, there is a pass through opening 17 which defines a maximum cutting cross-section. A pass through 18 is also disposed in the cutting box door 14 in order to be able to hand over the slices cut off by the cutting device 3 into the conveying portion 4 which connects to an outside of the cutting box door 14. The conveying portion 4 includes a conveying belt that is attached to the cutting box door 14, wherein the conveying belt can convey the slices cut off by the cutting device 3 depending on the selection of the conveying speed so that they stand adjacent to one another, are arranged in a fish-scale pattern or lie adjacent to one another. Typically, a complete packaging machine is placed adjacent to the machine 1 according to the invention, wherein the packaging machine typically packages a plurality of cut off portions into a self-service packaging unit.

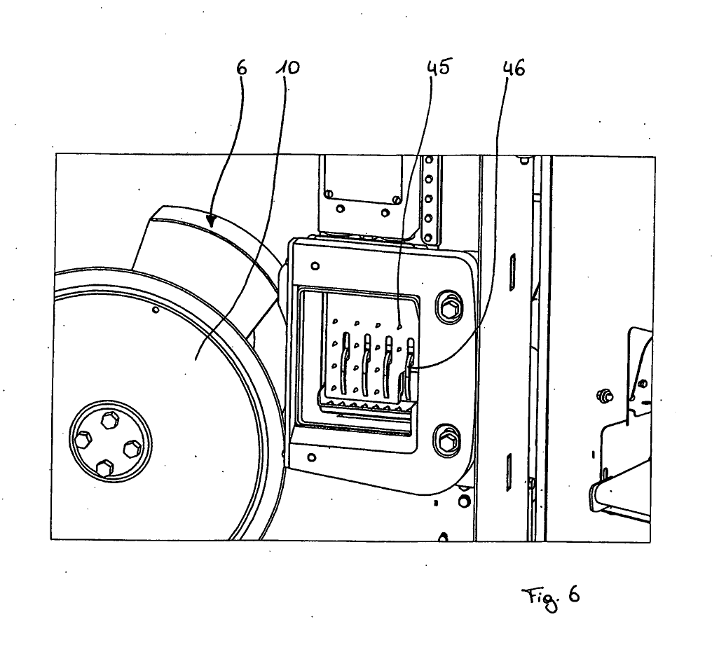

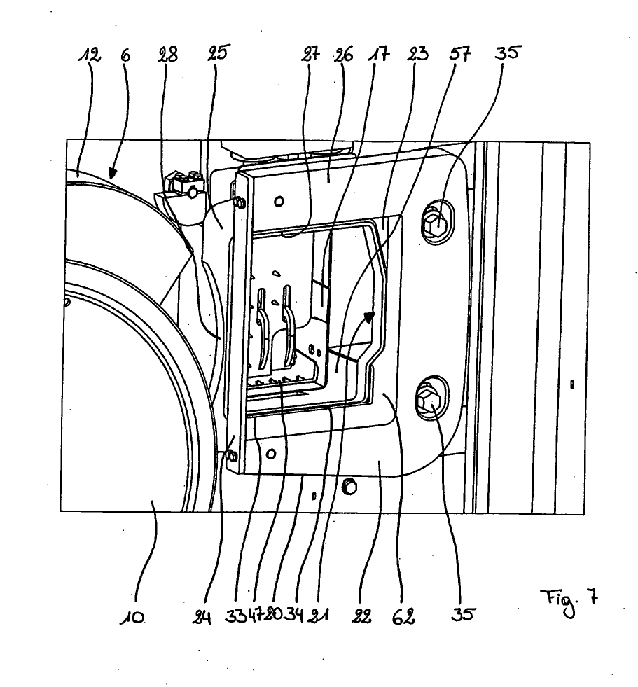

As evident from FIGS. 1-7, in particular FIGS. 6 and 7 that are drawn in a large scale, the pass through 17 is enclosed on all sides by a cutting frame 20 viewed in feed direction behind the circular blade 10, this means oriented towards the feed portion 4 and also by a cutting frame 21 viewed in feed direction in front of the circular blade 10. Both cutting frames 20, 21 respectively include a U-shaped main component 22, 23 and a rod-shaped connection arm 24, 25 respectively connecting the ends of two U-arms 26, 27 of the main components 22, 23 at the otherwise open side of the U, thus circumferentially closing the frame and providing it with high stability. The connection arms 25 of the cutting frame 21 arranged on the side of the cutting frame 21 is provided with an arc-shaped recess 28 which facilitates a collision free orbit of the rocker arm 12 of the rocker 6. While the rocker 6 is substantially aligned with the cutting frame 21, the circular blade 10 whose thickness is 6 mm enters a gap that is arranged between both cutting frames 20, 21 whose width is only slightly greater than 6 mm in order to provide a passage for the circular blade 10 through the gap portion without friction. While the cutting frame 21 is a cast component, the cutting frame 20 includes a plastic material in order to provide good emergency running properties.

While the circular blade in FIG. 1 due to the better illustration of the rocker 6 is disassembled and therefore not visible, the path of the circular blade 10 is visible from the sequence of FIGS. 2-5, wherein the rotation axis 9 as already recited moves on a circular path around the rotation axis 7 of the rocker 6.

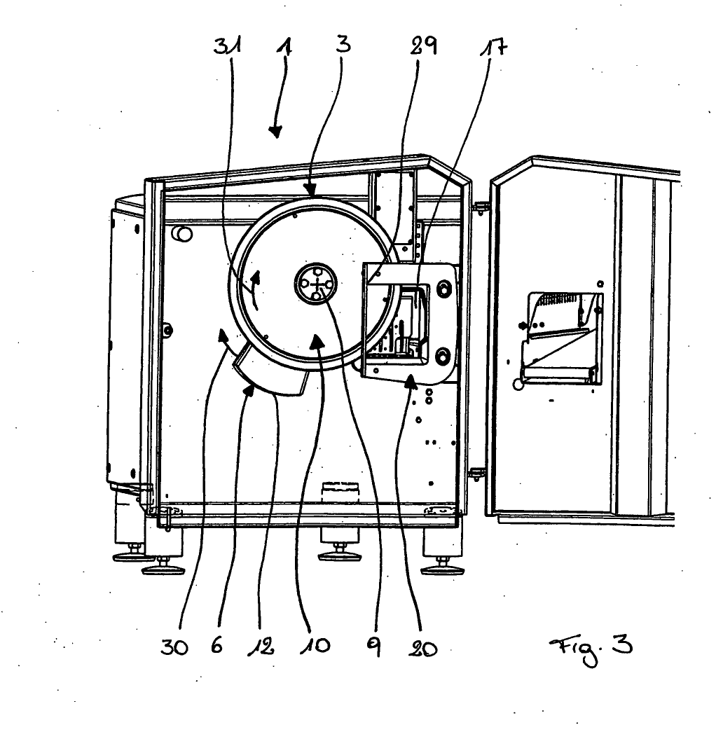

In FIG. 2 the circular blade 10 is in an upward movement at a slant angle towards the upper right, while the rocker arm 12 oriented away from the rotation axis 9 moves accordingly at a slant angle to the bottom left. FIG. 3 illustrates a position in which the circular blade 10 reaches the highest position with its rotation axis 9, this means the rocker arm 12 has already passed through its lowest position. The circular blade 10 has already penetrated the cutting cross-section defined by the openings 17, 18 within the cutting frames 20, 21, thus starting at the left upper corner, wherein the movement direction is oriented at a slant angle downward to the right. The rotation direction 30 of the rocker 6 and the rotation direction 31 of the circular blade 10 coincide (cf. arrows in FIG. 3) in order to sufficiently press the cutting material during the cutting process against the opposite cutting edges formed by the cutting frames 20, 21 (described infra in more detail) and thus to safely prevent a lift off.

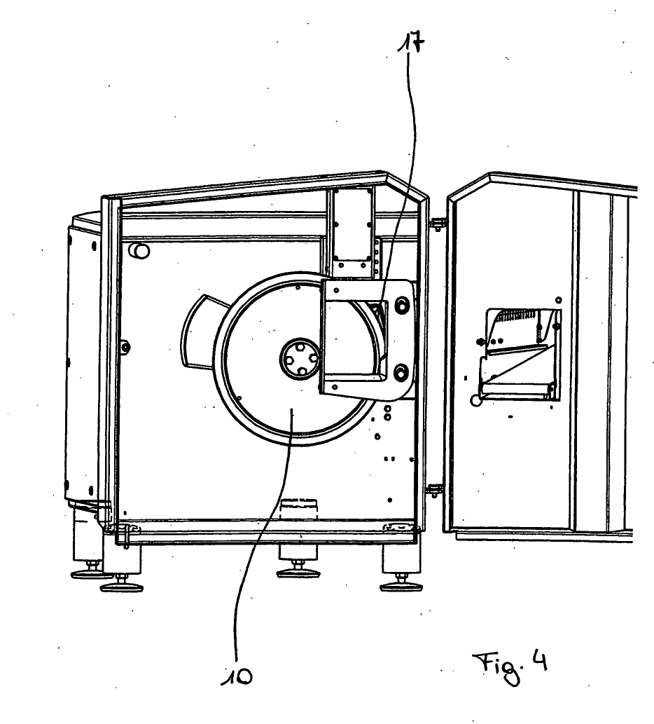

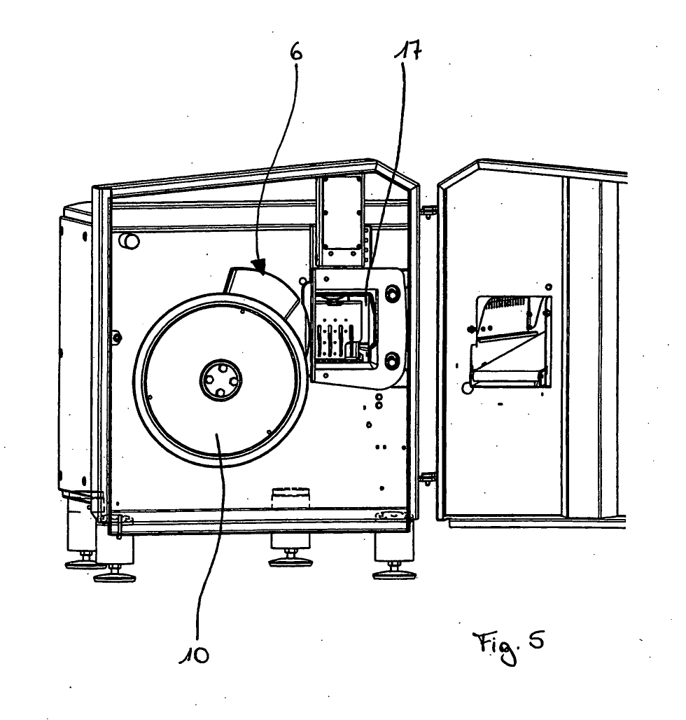

In the position according to FIG. 4 the circular blade 10 already starts again to slowly vacate the opening 17 (starting at the left upper corner) after also this portion was passed previously in a position that is not illustrated. In the position according to FIG. 5 the circular blade 10 due to an additional rotation of the rocker 6 has already completely left the opening 17 again.

It is evident from FIG. 1 that the rotation axis 7 of the rocker is approximately at the level of the horizontal center line 32 of the opening 17. This facilitates that the circular blade 10 when entering the cutting cross-section, (this means the pass through 17) has a movement direction that is oriented downward at a slant angle which causes the food to be cut to be pressed against the cutting frame 20, 21. In case of a too deep arrangement of the rotation axis 7, in particular in portions below a line which marks the bottom edge of the pass through 7, there is the risk that the food material is lifted off from the cutting frame 20, 21 during the cutting process which influences the cutting quality in a very negative manner.

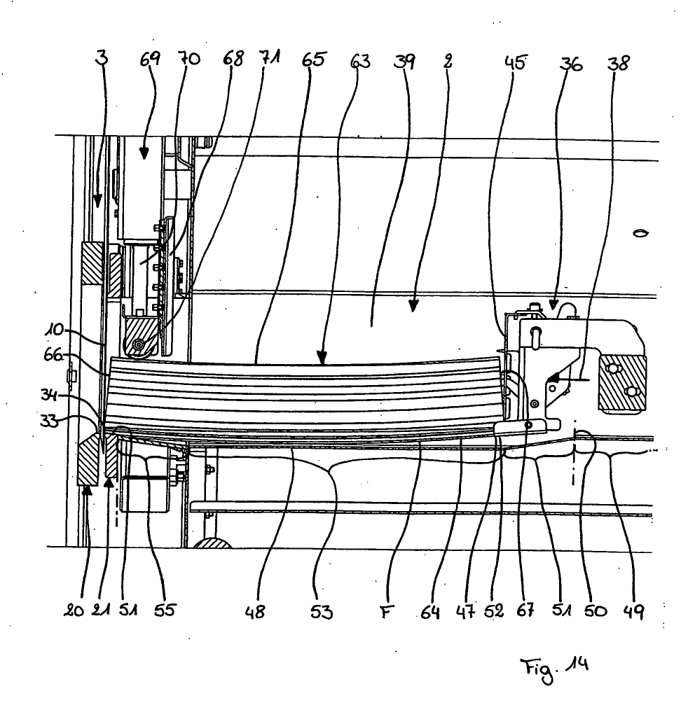

It is evident in turn from FIG. 7 that an opposite cutting edge 33 is configured at the cutting frame 20 oriented towards the conveying portion 4 and an opposite cutting edge 34 is configured at the cutting frame 21 oriented towards the feed portion 2. Both opposite cutting edges 33, 34 are configured with sharp edges with respect to the gap formed between the cutting edges as apparent among other things from the sectional view in FIG. 14 which will be described infra in more detail.

It is additionally illustrated in FIG. 7 that the cutting frame 20 oriented towards the conveying portion 4 is connected through two bolts 35 with the cutting frame 21 oriented towards the feed portion 2. The cutting frame 21 in turn is permanently connected with the machine housing 5 or through stiffeners and braces with a machine frame in the interior of the machine housing 5. The screws 35 are certainly so far away to the right from the pass through 17 that the circular blade 10 can orbit without collision in the gap between the cutting frames 20, 21. The circular blade 10, viewed in radially outward direction from the outside to the inside is undercut on both sides subsequent to a portion that is wedge-shaped and provided with teeth on the outer circumference, this means reduced with respect to its thickness in order to reduce friction with the food material to be cut.

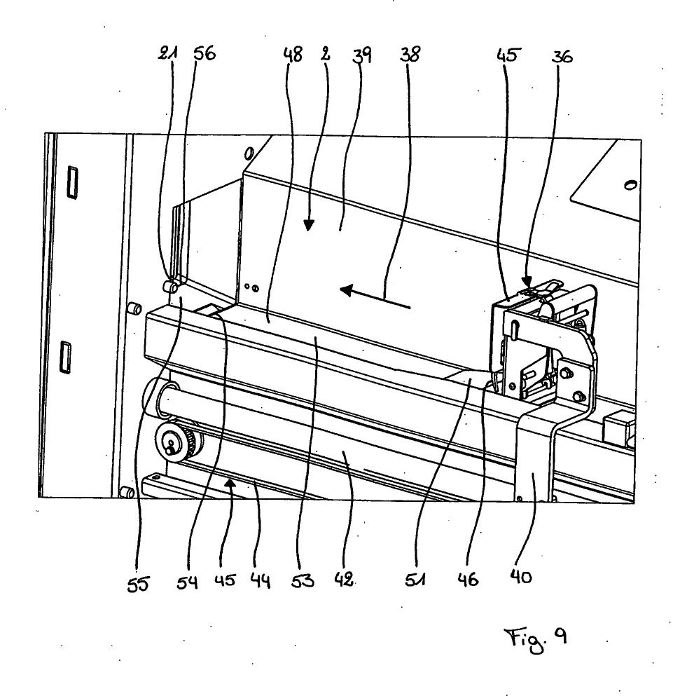

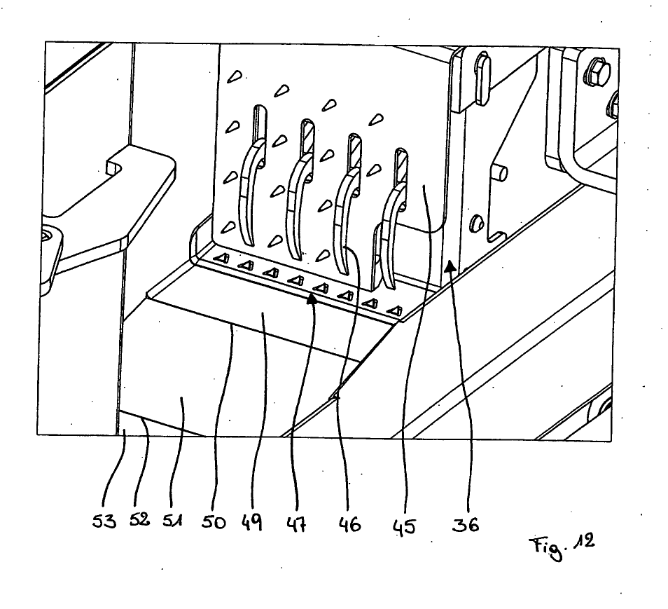

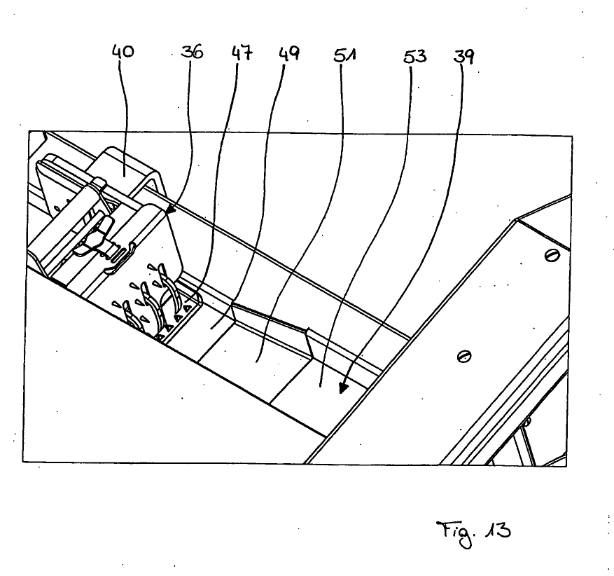

The configuration of the feed portion 2 can be derived in particular from FIGS. 8-13. A feed element 36 of a feed device 37 is configured as a slide which can be moved in feed direction 38. The feed element 36 is disposed within an elongated shaft 39 which has a rectangular cross-section. The feed element 36 is attached at a coupling arm 40 which is on the one hand side connected to a bushing 41 outside of the shaft 39 which forms a linear support for the feed element 36 together with a circular rod 42. On the other hand side the coupling arm 40 is connected through a perforated coupling rail 43 with a bottom portion 44 (cf. FIG. 9) of a belt drive 45. The belt drive 45 that is driven through a servo motor facilitates a precise and highly dynamic movement of the feed element 36. The latter is provided with a pressure plate 45 in a known manner, wherein the pressure plate is provided with spikes and interacts with a backside of a food strand (cf. later FIG. 14) and is provided with pivotable gripper hooks 46 which pass through adapted long holes in the pressure plate 45.

As apparent in particular from FIGS. 6-8 the feed element includes a protruding element 47 on its side oriented towards the cutting direction 3 (this means the cutting box 13), wherein the protruding element 47 forms a rear support portion for the food material strand. On its top side the protruding element 47 is provided with engagement elements also configured as spikes in order to facilitate form locking with the food material and in order to prevent a sliding of the food material strand in this manner.

It can be derived in particular from FIGS. 8-11 that the shaft 39 of the feed portion 2 is provided with a base 48 which extends on different levels. In one end portion 49 the base 48 extends horizontally thus up to an edge 50 which marks a transition to a transition portion 51 connecting in feed direction 38 with the end portion 39. In the transition portion 51 the base 48 extends with a downward sloping ramp. At another edge 52 the transition portion 51 terminates and a center portion 53 joins at a lower level than in the end portion 49. As apparent in particular from FIG. 9, the center portion 53 terminates at another edge 54 where a forward transition portion 55 begins that rises towards the cutting device 3.

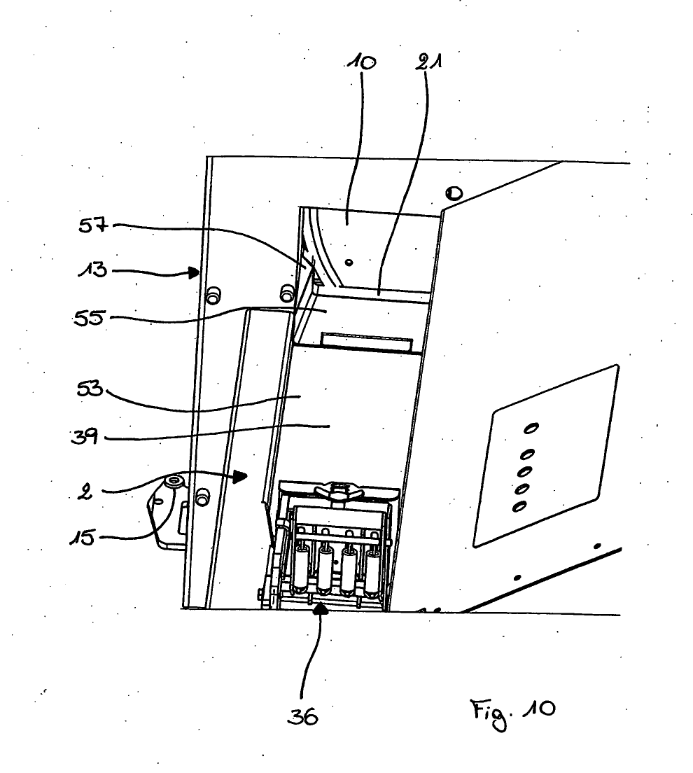

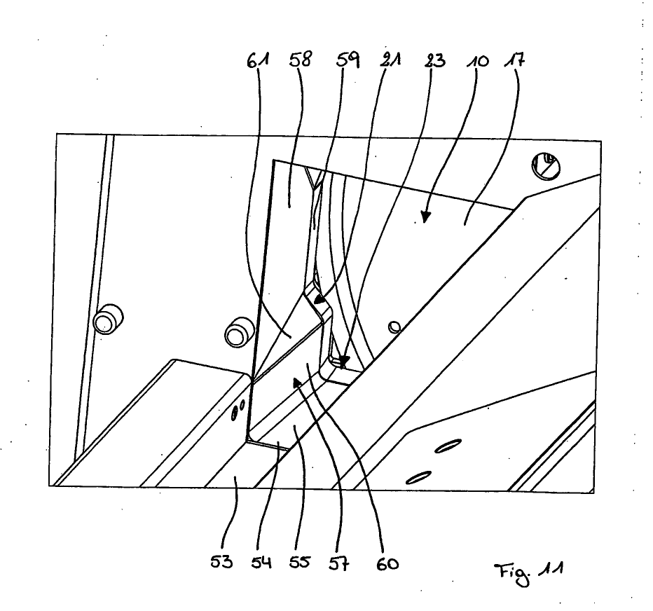

FIG. 11 illustrates that the transition portion 55 transitions at a line 56 into the cutting frame 21 that is also provided with the same inclination as the transition portion 55. This fact can also be derived from FIG. 10.

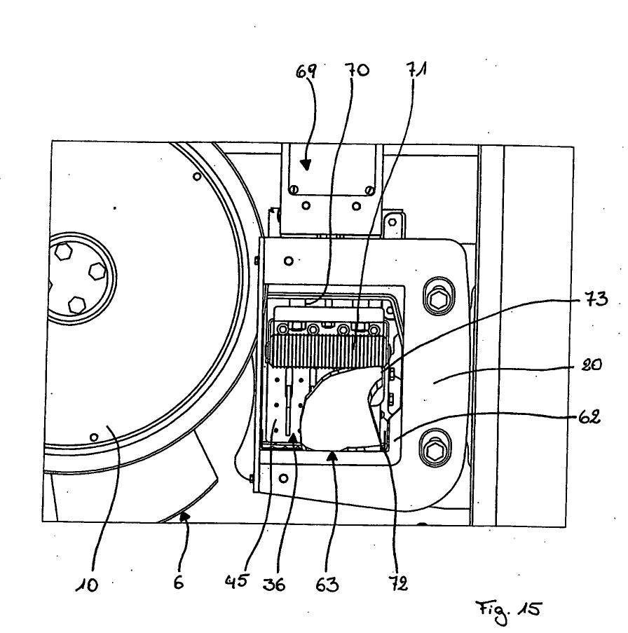

It is furthermore apparent from FIG. 11 that the feed cross-section tightens more and more in the transition portion 55 and in the cutting frame 21 in a lower portion which covers approximately 20% of the height of the entire opening 17. This contraction is facilitated through a wedge shaped support element 57 which provides a particularly good contact for the food material strands to a side wall 58 of the transition portion 55 or a vertical surface 59 of the cutting frame 51 in particular for food material strands with a concave lateral surface. This fact is described in more detail infra with reference to FIG. 15. The wedge shaped support element 57 includes a vertical wall 60 and an inclined triangular wall 61.

As apparent from FIG. 7 the wedge shaped support element 57 is also extended in the form of a support element in the cutting frame 20 oriented towards the transportation portion 4, wherein the support element 62 is integrally configured with the cutting frame 20.

A longitudinal sectional view of the feed portion 2 in which a food strand 63 configured as a pork chop strand is disposed is illustrated in FIG. 14. A free space F is provided in the position presently taken by the feed element 36 between a bottom side 64 of the food strand 63 and the base 48 of the duct 39, thus in the forward transition portion 55 and the center portion 53. In case the food strand 63 has a length of this type so that it also protrudes into the rear transition portion 51 which does not apply for the illustrated embodiment, a free space towards the base 58 would also be included at this location. Since the food material strand 63 is supported in a vertical direction only at 2 locations (forward and rear end section), thus at the cutting frame 21 associated with the feed portion 2 and at the protruding element 47 arranged at the feed element 36, the food material strand 63 based on its weight and inherent material elasticity slightly sags in downward direction. Thus, the free space F in the center of the food material strand 63, in spite a lower base in the center portion 53, has a smaller height than at the protruding element 47. In case the food material strand 63 has quasi indefinite stiffness, this means it would not sag under its own weight, the free space F in the center portion 53 would have the same height everywhere. The height would correspond to the distance between a bottom side of the protruding element 47 and a top side of the base 48 in the center portion 53. In the present case this height difference is 30 mm. The height difference between the top side of the base 48 in the end portion 49 and the top side of the base 48 in the center portion 53 is only slightly less. When the feed element 36 is moved back by a maximum amount against the feed direction 38, the leading edge of the protruding element 47 terminates with the edge 50 between the end portion 49 and the transition portion 51. The bottom sides of the feed element 36 and of the protruding element 47 thus almost come in contact with the top sides of the base 48 and the end portion 49.

Due to the sagging of the food material strand 63 its bottom side 64 viewed in longitudinal direction is convex, whereas a top side of the food material strand 63 is shaped concave accordingly. As a result a front face 66 and a rear face 67 of the food material strand 63 are inclined at an acute angle relative to one another.

The current cross section of the food material strand 63 can be determined through a laser detection device 68 arranged in the transition portion 55 and a target weight for a portion to be cut off can be adjusted there from through the respective feed amount. Through a hold down device 69 arranged behind the laser detecting device 68 using a feed device 38, wherein the hold down device 69 includes a down holder roller 71 arranged at two deployable plungers 70, the food material strand 63 can already be pressed strongly with its front end section towards the forward support portion S1 configured as a cutting frame 21 before the circular blade 10 and the food material strand 63. The fixation of the rear end section of the food material strand 63 at the rear support portion S2 configured as a protruding element 47 is performed through spikes arranged at this location and through the grappling hook 46.

Particularly good cutting properties and in particular a splinter free cutting of the bones included in the food material strand 63 is provided through a combination of the circular blade 10, which is at 6 mm very thin compared to the prior art, in combination with the opposite cutting edge 34 configured at the cutting frame 21 and the opposite cutting edge 33 configured at the cutting frame 20. Both opposite cutting edges 33, 34 are at the same level, this means they have no elevation difference from one another.

It is eventually apparent from FIG. 15 that the support element 62 at the cutting frame 20 and the support element 57 configured at the cutting frame 21 are adapted to the food material strand 63 which typically has a concave shape at its longitudinal side and which is configured as a pork chop strand.

A lower edge 72 of the food material strand 63 can come in contact at the corner portions configured at the support element 62 and 57 which would not be possible due to the overhanging upper “edge” 73 of the food material strand 63 without the wedge shaped support element 62 and 57. Thus, the food material strand 63 in the portion of the cutting frames 20, 21 is positioned also before the penetration of the circular blade 10 in combination with the down holder roller 71, so that a movement and resultant imprecision during cutting are excluded. Due to the rotation of the rocker 6 completely outside of the cutting cross section, cutting off the slices from the food material strand 63 is only performed through the very thin circular blade 10, so that a large wedge affect and thus splintering of the bones is safely prevented through the two supporting cutting edges 33, 34.

### Reference Numerals and Designations:

1 machine

2 feed portion

3 cutting device

4 conveying portion

5 machine housing

6 rocker

7 rotation axis

8 distance

9 rotation axis

10 circular blade

11 rocker arm

12 rocker arm

13 cutting box

14 cutting box door

15 hinge

16 face wall

17 pass through

18 pass through

19 conveying belt

20 cutting frame

21 cutting frame

22 main portion

23 main portion

24 connection arm

25 connection arm

26 U-arm

27 U-arm

28 cut out

29 corner

30 rotation direction

31 rotation direction

32 center line

33 opposite cutting edge

34 opposite cutting edge

35 bolt

36 feed element

37 feed device

38 feed direction

39 shaft

40 coupling arm

41 bushing

42 rod

43 coupling rail

44 bottom portion

45 compression plate

46 grappling hook

47 protruding element

48 base

49 end portion

50 edge

51 transition portion

52 edge

53 center portion

54 edge

55 transition portion

56 line

57 support element

58 side wall

59 surface

60 wall

61 wall

62 support element

63 food material strand

64 bottom side

65 bottom side

66 face

67 face

68 laser scanner

69 hold down device

70 plunger

71 hold down roller

72 edge

73 edge

F free space

S1 support portion

S2 support portion

K circular path Docket No.

What is claimed is:

1. A machine for cutting a strand shaped food material, in particular meat or cheese, into slices, comprising:
a housing;
a feed portion;
a feed device;
a cutting device including a rocker pivoting about a first rotation axis fixated at the housing; and
a conveying portion,
wherein a food material strand is moveable in a feed direction from the feed portion through a the feed device towards the cutting device
wherein a circular blade is supported at the rocker and configured to be driven in rotation about a second rotation axis and configured to cut successive slices from a front face of the food material strand,
wherein the slices are transferable into the conveying portion after being cut off from the food material strand,
wherein the feed direction (38) is substantially horizontal, and
wherein a circular path on which the second rotation axis orbits is arranged completely outside of a maximum cutting cross section.

2. The machine according to claim 1, wherein the first rotation axis is arranged above a straight line defining an opposite cutting edge of the feed portion.

3. The machine according to claim 1, wherein a horizontally extending cutting edge of the feed portion and an opposite horizontally extending opposite cutting edge of the conveying portion extend approximately at an identical level.

4. The machine according to claim 1, wherein the rocker is drivable through a proper drive motor and the circular blade is drivable through a proper drive motor.

5. The machine according to claim 4, wherein a ratio of a speed of the circular blade to a speed of the rocker is at least 3:1 for a non-frozen food material or at least 6:1 for a partially frozen food material.

6. The machine according to claim 1, wherein the circular blade has a thickness of less than 10 mm a diameter greater than 500 mm.

7. The machine according to claim 1 6, wherein the circular blade has an undercut in a longitudinal cross sectional view on both sides subsequent to a wedge portion.

8. The machine according to claim 1, further including a conveyor belt arranged in the conveying portion.

9. The machine according to claim 1, wherein a cutting frame of the feed portion or a cutting frame of the conveying portion are assembled from an integrally configured U-shaped main component and a connection arm that connects ends of two U-arms of the main component, is arranged vertically and oriented towards the first rotation axis.

10. The machine according to claim 8, wherein an opposite cutting edge of the conveying portion is permanently connected with an opposite cutting edge of the feed portion, wherein the conveying belt is attached at a cutting box door which is pivotably supported about a vertical axis at the machine frame or the machine housing.

11. The machine according to claim 2, wherein the first rotation axis is arranged above a horizontal center plane of the maximum cutting cross section or at a distance laterally adjacent to a straight line which laterally defines the maximum cutting cross section.

12. The machine according to claim 4, wherein a ratio of a speed of the circular blade to a speed of the rocker is at least 3:1 for a non-frozen food material or at least 8:1 for a partially frozen food material.

13. The machine according to claim 4, wherein a ratio of a speed of the circular blade to a speed of the rocker is at least 3:1 for a non-frozen food material and at least 6:1 for a partially frozen food material.

14. The machine according to claim 4, wherein a ratio of a speed of the circular blade to a speed of the rocker is at least 3:1 for a non-frozen food material and at least 8:1 for a partially frozen food material.

15. The machine according to claim 6, wherein the circular blade has a thickness of less than 8 mm.

16. The machine according to claim 6, wherein the circular blade has a thickness of less than 6 mm.

17. The machine according to claim 6, wherein the circular blade has a diameter greater than 600 mm.

18. The machine according to claim 6, wherein the circular blade has a diameter greater than 700 mm.

19. The machine according to claim 6, wherein the circular blade has a thickness of less than 6 mm and a diameter greater than 700 mm.

20. The machine according to claim 7, wherein the wedge portion includes teeth.

21. The machine according to claim 8, wherein the conveyor belt is directly adjacent to a cutting frame arranged in the conveying portion and forming an opposite cutting edge.

22. The machine according to claim 8,
wherein the opposite cutting edge of the conveying portion is a cutting frame of the conveying portion at which the opposite cutting edge of the conveying portion is configured, and is permanently connected with an opposite cutting edge of the feed portion, and
wherein the opposite cutting edge of the feed portion is a cutting frame of the feed portion at which the opposite cutting edge of the feed portion is configured, and is permanently connected with the machine frame or the machine housing.
